(19) United States
(12) Patent Application Publication
(10) Pub. No.: US 2008/0003400 A1
(43) Pub. Date: Jan. 3, 2008

(54) Method for making a pile fabric and pile fabric made thereby

(75) Inventor: Kenneth Tseng, Chiayi Hsien (TW)

Correspondence Address: LADAS PARRY, Suite 2100, 5670 Wilshire Boulevard, Los Angeles, CA, 90036-5679, US

(73) Assignee: CANBELIN INDUSTRIAL CO., LTD.

(21) Appl. No.: 11/479,805

(22) Filed: Jun. 30, 2006

(51) Int. Cl. B32B 33/00

(52) U.S. Cl. 428/92; 428/91

(57) ABSTRACT

A method for making a pile fabric includes the steps of: preparing a polypropylene melt containing a softener; spinning the polypropylene melt into filaments; cutting the filaments into staple fibers; forming tufted yarns by braiding or twisting the staple fibers with polypropylene backbone yarns each having at least two braided or twisted polypropylene strands, the staple fibers projecting outwardly from the polypropylene backbone yarns; and interlacing the tufted yarns with non-tufted polypropylene yarns.

### BACKGROUND OF THE INVENTION

1. Field of the Invention

The invention relates to a method for making a pile fabric, more particularly to a method for making a pile fabric from polypropylene. The invention also relates to a pile fabric made from polypropylene.

2. Description of the Related Art

A conventional pile fabric is made from staple fibers, such as cotton fibers, rayon fibers, or acrylic fibers. However, since such staple fibers are liable to absorb water, the conventional pile fabric may cause the production of fungus and foul odor, and is thus not suitable for outdoor use.

In order to solve the aforesaid problem, a polypropylene material, which is non-absorbent for water, is used for making a fabric. However, polypropylene fibers are relatively rigid and difficult to be cut into staple fibers. Therefore, the polypropylene fibers are not used for making a pile fabric to date.

### SUMMARY OF THE INVENTION

Therefore, the object of the present invention is to provide a method for making a pile fabric which is non-absorbent for water.

In the first aspect of this invention, a method for making a pile fabric includes the steps of:

a) preparing a polypropylene melt containing a softener;

b) spinning the polypropylene melt into filaments;

c) cutting the filaments into staple fibers;

d) forming tufted yarns by braiding or twisting the staple fibers with polypropylene backbone yarns each having at least two braided or twisted polypropylene strands, the staple fibers projecting outwardly from the polypropylene backbone yarns; and

e) interlacing the tufted yarns with non-tufted polypropylene yarns.

In the second aspect of this invention, a pile fabric includes a plurality of non-tufted polypropylene yarns, and a plurality of tufted polypropylene yarns interlaced with the non-tufted polypropylene yarns. Each of the tufted polypropylene yarns includes a polypropylene backbone yarn having at least two braided or twisted polypropylene strands, and a plurality of staple polypropylene fibers braided or twisted with and projecting outwardly from the polypropylene backbone yarn. The staple polypropylene fibers are made of a polypropylene melt containing a softener.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart of the preferred embodiment of a method for making a pile fabric according to this invention;

FIG. 2 is a fragmentary perspective view of a tufted yarn formed according to the preferred embodiment;

FIG. 3 is a schematic sectional view of the tufted yarn; and

FIG. 4 is a schematic view of the pile fabric made by the preferred embodiment.

### DETAILED DESCRIPTION OF THE PREFERRED EMBODIMENT

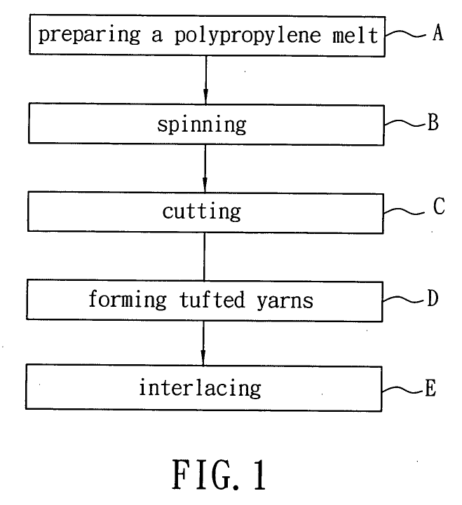

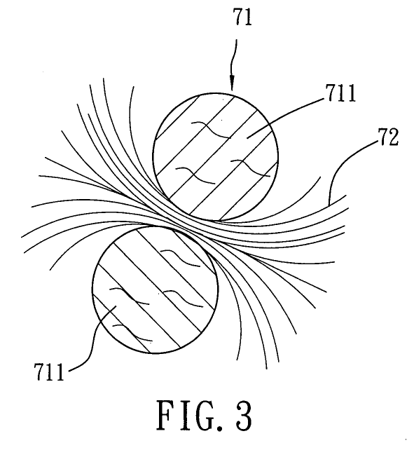

Referring to FIGS. 1, 2, 3 and 4, the preferred embodiment of the method for making a pile fabric according to this invention comprises the steps of:

A) Preparing a Polypropylene Melt:

Polypropylene particles are molten and blended with a colorant, and a softener is then added so as to obtain a polypropylene melt. Preferably, the amount of the added softener ranges from 1 to 1.5 wt % based on a total weight of the polypropylene melt, and the amount of the added colorant ranges from 3 to 6 wt % based on the total weight of the polypropylene melt. The softener suitable for this invention is amino silicone.

B) Spinning:

The polypropylene melt is spun into filaments in any suitable manner well known in the art.

C) Cutting:

The filaments are cut into staple fibers 72.

D) Forming Tufted Yarns:

The staple fibers 72 are braided or twisted with polypropylene backbone yarns 71, each of which has two braided or twisted polypropylene strands 711, to form tufted yarns 7. The staple fibers 72 project outwardly from the polypropylene backbone yarns 71.

E) Interlacing:

The tufted yarns 7 are interlaced with non-tufted polypropylene yarns 8 so as to obtain the pile fabric.

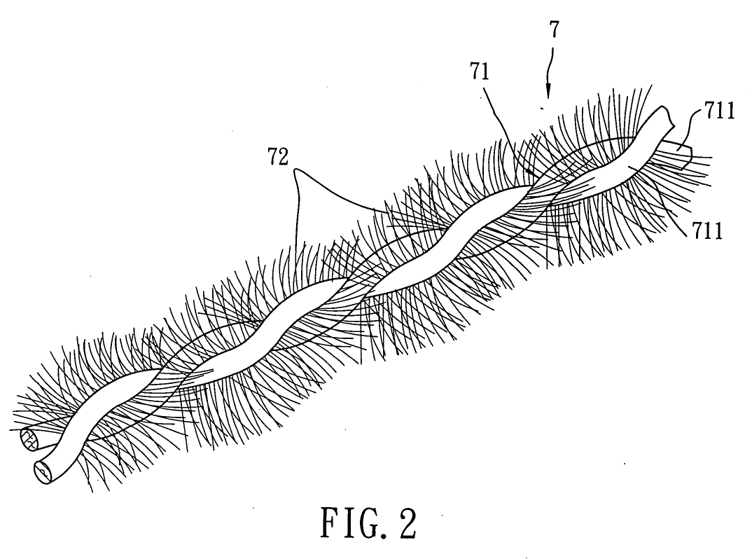

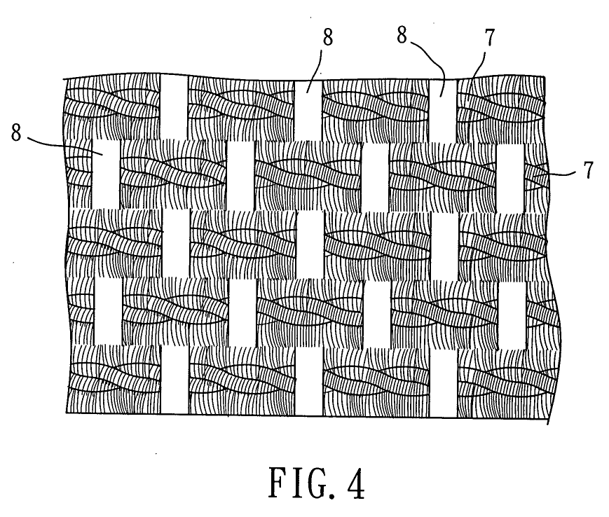

Specifically referring to FIGS. 2 and 4, the pile fabric made by the preferred embodiment of the method according to this invention includes a plurality of the non-tufted polypropylene yarns 8, and a plurality of the tufted polypropylene yarns 7 interlaced with the non-tufted polypropylene yarns 8. Each of the tufted polypropylene yarns 7 includes the polypropylene backbone yarn 71 having two braided or twisted polypropylene strands 711, and a plurality of the staple polypropylene fibers 72 braided or twisted with and projecting outwardly from the polypropylene backbone yarn 71.

In view of the aforesaid, since the polypropylene melt contains the softener, the filaments made from the melt can be easily cut into staple fibers for making the pile fabric. Furthermore, since the polypropylene is non-absorbent for water, the pile fabric made therefrom will not have the problem of the production of fungus and foul odor, which is encountered in the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for making a pile fabric, comprising the steps of:
a) preparing a polypropylene melt containing a softener;
b) spinning the polypropylene melt into filaments;
c) cutting the filaments into staple fibers;
d) forming tufted yarns by braiding or twisting the staple fibers with polypropylene backbone yarns each having at least two braided or twisted polypropylene strands, the staple fibers projecting outwardly from the polypropylene backbone yarns; and
e) interlacing the tufted yarns with non-tufted polypropylene yarns.

2. The method as claimed in claim 1, wherein the polypropylene melt further includes a colorant.

3. The method as claimed in claim 1, wherein the softener includes amino silicone.

4. The method as claimed in claim 2, wherein the amount of the softener ranges from 1 to 1.5 wt % based on a total weight of the polypropylene melt.

5. The method as claimed in claim 2, wherein the amount of the colorant ranges from 3 to 6 wt % based on a total weight of the polypropylene melt.

6. A pile fabric, comprising:
a plurality of non-tufted polypropylene yarns; and
a plurality of tufted polypropylene yarns interlaced with said non-tufted polypropylene yarns,
wherein each of said tufted polypropylene yarns includes a polypropylene backbone yarn having at least two braided or twisted polypropylene strands, and a plurality of staple polypropylene fibers braided or twisted with and projecting outwardly from said polypropylene backbone yarn, and
wherein said staple polypropylene fibers are made of a polypropylene melt containing a softener.
